(19) United States
(12) Patent Application Publication
(10) Pub. No.: US 2008/0270909 A1
(43) Pub. Date: Oct. 30, 2008

(54) Methods and Apparatuses to Provide Premium Contents over Internet

(75) Inventors: Matthew KAUFMAN, Redwood City, CA (US); John DOWD, San Jose, CA (US); Vidar HOKSTAD, London (GB)

Correspondence Address: GREENBERG TRAURIG, LLP (SV);IP DOCKETING, 2450 COLORADO AVENUE, SUITE 400E, SANTA MONICA, CA, 90404, US

(73) Assignee: LOOKSMART, LTD., San Francisco, CA (US)

(21) Appl. No.: 12/108,483

(22) Filed: Apr. 23, 2008

Related U.S. Application Data
(60) Provisional application No. 60/914,019, filed on Apr. 25, 2007.

(51) Int. Cl. G06F 3/00; G06F 3/01

(52) U.S. Cl. 715/738; 715/760

(57) ABSTRACT

Systems and methods to provide premium content over Internet with in place preview. In one embodiment, a method includes: providing a representation of content to a first user, the representation of the content embeddable by the first user into a web page; receiving a request from a browser after the web page having the representation of the content is rendered in the browser; responsive to the request, presenting a user interface to process a payment to access the content without the browser leaving the web page; and upon completion of the payment, presenting the content in the browser.

### RELATED APPLICATIONS

The present application claims priority to the Provisional U.S. Patent Application Ser. No. 60/914,019, filed Apr. 25, 2007, the disclosure of which is hereby incorporated herein by reference.

### FIELD OF THE TECHNOLOGY

At least some embodiments of the disclosure relate to user interfaces in general, and more particularly but not limited to, web based user interfaces for distribution of premium contents.

### BACKGROUND

The patterns by which people receive information have been transformed since the use of the Internet became widespread and throughout its evolution. Whereas once people consulted larger, general information sources, the trend today is to consult smaller, specialized information sources. Thus, the traffic to larger, general information sources is reduced today in favor of smaller, specialized information sources. Naturally, the owners of the smaller, specialized marketplaces seek to capitalize on listings revenues, but often lack the personnel and other resources to efficiently display listings in their marketplaces.

During the 1990s, the Internet was dominated by large marketplaces. A marketplace is an online or offline venue that facilitates commerce and may range from large websites to small websites to offline print sources to individuals. Over the history of the Internet, a gradual shift from large, varied content marketplaces to smaller, more specialized marketplaces has occurred. This shift, naturally, has led to a revitalization of ways in which content owners, such as advertisers, generate revenue. Many larger marketplaces are loosing traffic to the more specialized marketplaces, which has caused content owners to reevaluate how and where advertising money is spent.

At the same time, however, the more specialized marketplaces tend to be smaller operations. Often, these marketplaces are created, maintained, and run by individuals or small groups of individuals. Although the marketplaces generate increasing levels of traffic, the overall traffic is relatively small compared to the traffic of the larger marketplaces. Thus, small marketplaces often struggle to attract larger advertising revenues that reflect their increased traffic because these smaller marketplaces do not have the personnel and resources to create and implement extensive advertising schemes. Thus, small marketplaces, although attracting traffic that has traditionally gone to larger marketplaces, are often unable to capture advertising revenues that should follow the increased traffic to their marketplaces.

Moreover, small marketplaces tend to be specialized and exist with other small marketplaces specializing in the same or similar subject matter. The competing marketplaces often exist in niches that appeal to various groups of traffic, and often include subsets of the same users. These small marketplaces form niche communities, and the owners of the marketplaces tend to be aware of, and in some cases collaborate with, the other similar marketplaces in the niche communities.

U.S. Pat. No. 6,389,541 discloses a method to regulate access to digital content, in which digital content such as text, video, and music are stored as part of a compressed and encrypted data file, or object, at a client computer, such as a personal home computer. The content is inaccessible to a user until a payment or use authorization occurs.

### SUMMARY OF THE DESCRIPTION

Systems and methods to provide premium content over Internet with in place preview are described herein. Some embodiments are summarized in this section.

In one embodiment, a method includes: providing a representation of content to a first user, the representation of the content embeddable by the first user into a web page; receiving a request from a browser after the web page having the representation of the content is rendered in the browser; responsive to the request, presenting a user interface to process a payment to access the content without the browser leaving the web page; and upon completion of the payment, presenting the content in the browser.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a method provide contents according to one embodiment.

FIG. 2 shows an example of providing a reduced version of content according to one embodiment.

FIGS. 3-6 show an example of processing payments to access premium content according to one embodiment.

FIG. 7 illustrates an in-line presentation of a user interface to process payments according to one embodiment.

FIG. 8 shows a method to create an embeddable presentation of premium content according to one embodiment.

FIG. 9 shows a method to distribute contents according to one embodiment.

FIG. 10 shows a system to provide premium contents according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, premium content requires payment before it can be viewed; a premium content owner is a first entity that owns premium content; a premium content affiliate is a second entity that sells access to premium content on behalf of the premium content owner; a premium content customer is a third entity that purchases the premium content; and a premium content link is a button, hyperlink, or widget, that previews the premium Content and allows a customer to purchase “in place” at where the premium content link is presented.

In one embodiment, premium content can be viewed/purchased “in place” at where the premium content link is embedded. The premium content link can be configured to be embedded in various web pages to allow premium content be presented anywhere on the Internet. In one embodiment, a “premium content link” (e.g., hyperlink, button, graphic, widget, etc.) is created for embedding in any web page. The premium content link allows a premium content customer to preview, purchase, and view the content without moving away from the web page where the premium content link first appeared. One or more of the following technologies can be used to power the premium content link: Flash, HTML, and JavaScript.

Advantages of this approach include: content can be viewed where consumers are; and content is decoupled from the entity that generated the content.

In one embodiment, a website owner who displays premium content link can be a premium content affiliate. Anyone who wants to add a premium content link to their website can become a premium content affiliate. In one embodiment, affiliates receive a pre-defined percentage of the premium content sale price. The relationship between the affiliate and content owner is handled by a web-based system.

Advantages of this approach include: affiliates can earn revenue from distributing the premium content; and people are incentivized to distribute premium content well beyond where that content was originally generated.

In one embodiment, a web-based system for the “in place” presentation and use of premium content links does not host at least part of the premium content. In one embodiment, the web-based system provides a wrapper to the premium content rather than host the content on their servers. The premium content owner provides the web-based system with pricing and descriptive information to sell the content along with a pointer to another server where the content resides. In some embodiments, a premium content owner may elect to upload content to the web-based system rather than host the content elsewhere.

Advantages of this approach include: the web-based system can leverage existing content distribution systems (YouTube, Google Video, etc.); and premium content owners can leverage their own DRM (Digital Rights Management) systems if they choose to protect the premium content via a DRM system.

In one embodiment, the web-based system uses technologies to enable premium content to be viewed and purchased in place.

In one embodiment, a Flash widget or an IFrame is used to enable a secure connection within an unsecured web page. Most web pages are not secure; however, accepting payment information requires passing account numbers over a secure connection. To handle a secure transfer of data within an insecure page, a Flash widget or an IFrame can be used. For example, a Flash widget can be used to handle all secure communications to the servers of the web-based system. For example, an IFrame can be implemented to point to secure content from within a web page hosting the premium content link. The IFrame can be launched with a small Java Script included in the premium content link.

In one embodiment, content is dynamically published to the web page that contains the premium content link. In order to show content “in place,” the web page that hosts the premium content link is dynamically updated. For example, a Flash Widget or IFrame can be placed within the web page that hosts the premium content link to dynamically update the content to show the interface for payment processing and to provide premium content after the payment. In one embodiment, the website owner can enable this functionality by adding a small piece of JavaScript to the page.

In one embodiment, the space allocated for the premium content preview, payment processing, and/or the presentation of the premium content can be dynamically resized on the web page that contains the premium content link. When a website owner includes an IFrame or Flash Widget, they may specify the height of that widget. The web-based system can dynamically resize widget depending on the state of the purchase/view flow. A combination of pop-ups and forced page refreshes can be used to resize, where the size of the widget is passed as a URL parameter to the parent page. Alternatively, a script in the premium content link can interact with the browser to dynamically change at least a portion of the web page allocated for the premium content preview, payment processing, and/or the presentation of the premium content

In one embodiment, the web-based system serves content creators who want to monetize their content, such as bloggers, researchers, podcasters, bloggers, and/or those who want to distribute content for a fee. The web-based system provides a buy and view in-place solution that makes content creators money by being simple to use and easy to distribute.

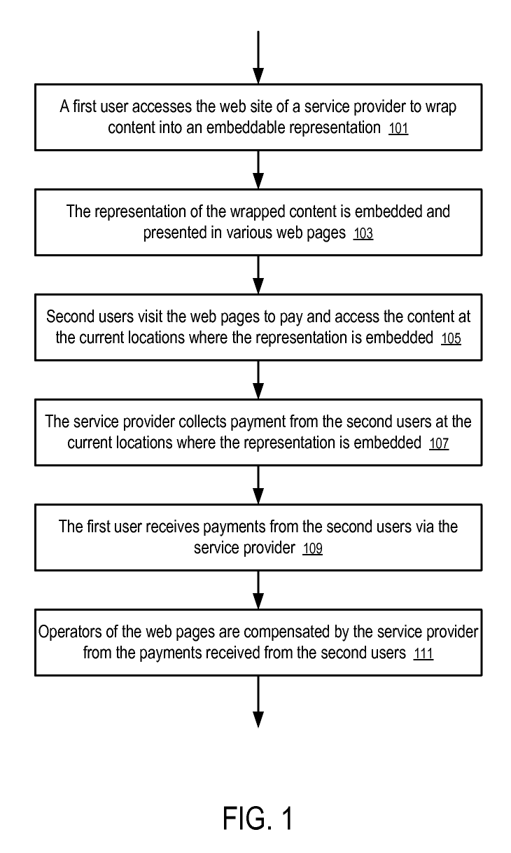

FIG. 1 shows a method provide contents according to one embodiment. In FIG. 1, a first user accesses (101) the web site of a service provider to wrap content into an embeddable representation. The representation of the wrapped content is embedded and presented (103) in various web pages. Second users visit (105) the web pages to pay and access the content at the current locations where the representation is embedded. The service provider collects (107) payment from the second users at the current locations where the representation is embedded. The first user receives (109) payments from the second users via the service provider. Operators of the web pages (111) (e.g., the owners of the web pages, or the hosts of the web pages) are compensated by the service provider from the payments received from the second users. In one embodiment, the embeddable representation provided to different operators has different identifiers to track the contribution of the operators in distributing the premium content.

In a typical flow in one embodiment, an owner creates content and allows the web-based system to wrap the content via a premium content link. The premium content links can be placed on the site of the owner and/or the sites of others (premium content affiliates). The users pay and view the premium content in place at the respective sites where the premium content links are hosted.

In a typical revenue flow in one embodiment, the web-based system charges the customers on behalf of the owner and/or premium content affiliates and compensates site owners with affiliate revenue and the content owner accordingly.

For example, when the premium content link is distributed via the web site of the content owner, the content owner earns a list price specified by the owner, less a fee earned by the web-based system.

For example, when the premium content link is distributed via the web site of an affiliate, a web site owner responsible for distributing the premium content link earns affiliate revenue when the user of the web site pays and views at the current location of the web site; and the content owner earns a list price specified by the owner, less a fee earned by the web-based system and the affiliate fee earned by the web site owner.

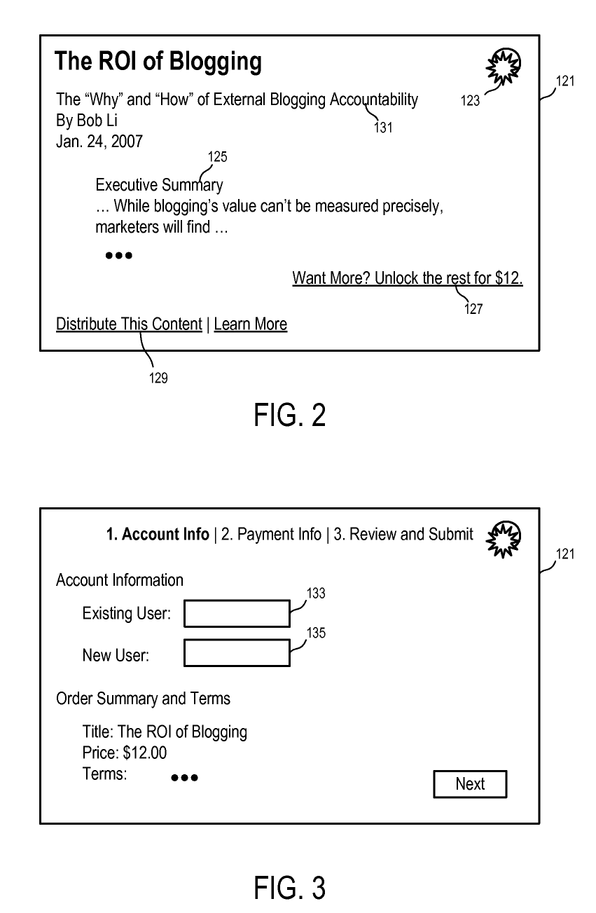

FIG. 2 shows an example of providing a reduced version of content according to one embodiment. In FIG. 2, the reduced version of the content is presented in the area (121) of a web page. The area (121) can be a portion of the web page in which a premium content link is inserted or the entire web page rendered in a web browser.

For example, after a user navigates to a web site where the premium content link is hosted, a preview section of the premium content is provided at the place where the premium content link is embedded. An example layout of a preview section may include a title, a description, a teaser of premium content with links to start a payment process to access the full version, and an optional further description after the teaser of the premium content. The teaser of premium content can be a selected portion of the premium content.

In FIG. 2, the content includes an article. The reduced version of the content includes a title of the article (e.g., “The ROI of Blogging”), a brief description (131) of the article, the author and date of the article, a portion of the executive summary (125) from the content, etc.

Based on the types of the premium contents, a reduced version of the content can include a title, a brief description, an abstract, a summary, a video clip, an audio clip, a thumbnail image, and/or a selected portion.

In FIG. 2, the reduced version of the content includes an icon (123) associated with the web-based system. The icon (123) allows the user to easily identify the opportunity to pay for access to premium content via the secure and convenient service of the web-based system.

In FIG. 2, a link (127) is presented with a price to access the content. A user can select the link (127) to start an in-place payment processing user interface.

In FIG. 2, a link (129) is also presented to allow the user obtain a premium content link for distribution of the content. The user can embed the obtained premium content link in his/her web pages and earn affiliate revenue when visitors of his/her web pages purchase the content via the premium content link embedded in his/her web pages.

Such an approach simplifies the process to re-distribute premium content, improves the user experience by fully integrating the preview, payment and viewing of premium contents in the environment where the premium content links are embedded, allows affiliates to distribute contents without having to copy the contents, allows the content owner to maintain control of the premium content, and allows the premium content to propagate over the Internet for wide distribution.

After an affiliate embeds the premium content link in the web page of the affiliate, the web-based system can provide the user interface for preview, payment processing and presentation of the premium content, in place at the web page of the affiliate in a same way as in the web page of the content owner that has the embedded premium content link. The premium content link customized for the affiliate allows the affiliate to earn the affiliate revenue, while providing the consistent user interface to end users for preview, payment processing and presentation of the premium content.

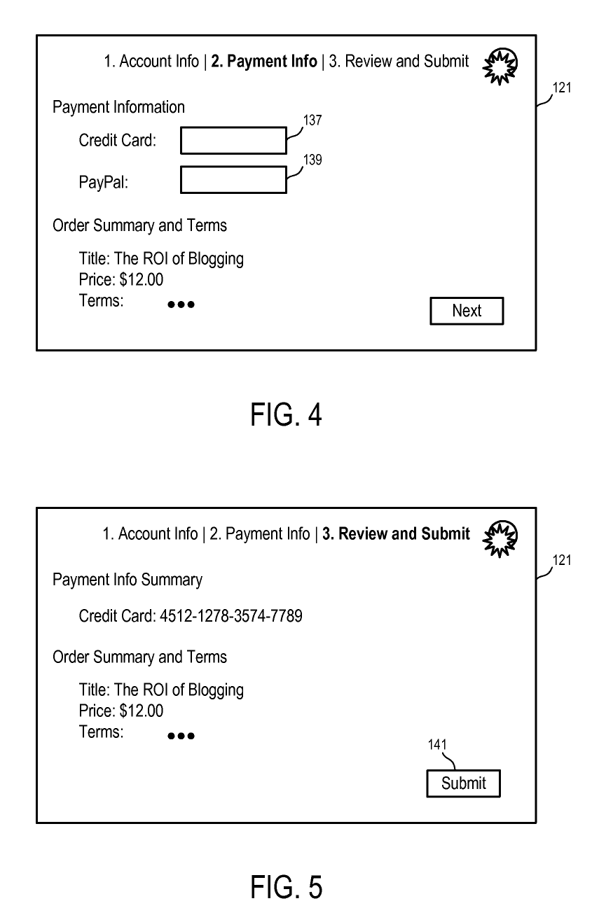

FIGS. 3-6 show an example of processing payments to access premium content according to one embodiment. In one embodiment, the content of the payment processing user interface replaces the reduced version of the content in the web page. In one embodiment, the user interface for the payment processing is overlaid on top of the preview section. Alternatively, the user interface for the payment processing can be presented in a pop-up window, while the reduced version of the content is displayed in the web page in a main window.

In FIG. 3, the user interface presents order summary and terms and allows the user to identify account information. For example, an existing user may enter the user name in the entry box (133) to access a pre-established account with the web-based system; and a new user may select a user name in the entry box (135) to request a new account with the web-based system. Access to the user accounts can be authenticated via various methods, such as password, pin number, identification of the user device, etc., to prevent fraud and/or unauthorized access.

In FIG. 4, the user interface allows the user to identify or confirm the payment information, such as a credit card number in entry box (137), or a PayPal account number in entry box (139). Other types of payment information, such as bank accounts, debit accounts, etc., can also be used in some embodiments. An existing

In FIG. 5, the user interface allows the user to review the order and select the submit button (141) to place the order.

FIG. 6 shows an example of order confirmation with an icon button (143) to request the full version of the content. In one embodiment, after the icon button (143) is selected, the full version of the content is presented in the area where the confirmation (and/or the preview) was presented. For example, the preview section of the web page (or the pop-up window showing the confirmation) id dynamically resized to accommodate the presentation of the full version of the premium content.

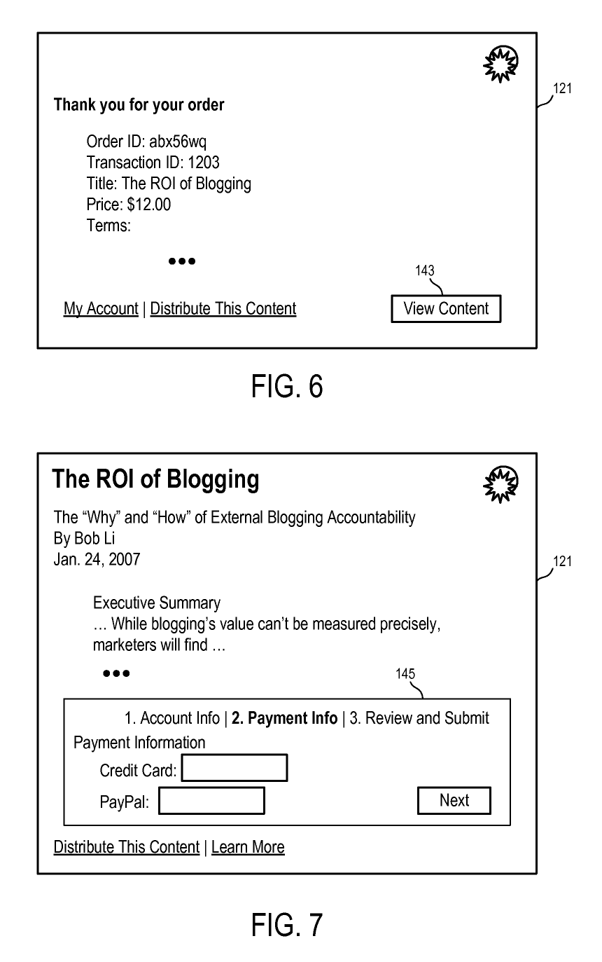

FIG. 7 illustrates an in-line presentation of a user interface to process payments according to one embodiment. For example, after the user selects the link (127) to request access to the full version of the premium content, a payment processing section (145) is inserted in-line at the place where the link (127) was, as illustrated in FIG. 7. The payment processing section (145) can be used to present user interfaces to identify customer accounts and payment information, to review and submit order, to request the presentation of the premium content.

In one embodiment, the premium content is unlocked and presented in a window separate from the window in which the preview is presented. Alternatively, the premium content is presented in the section that was previously used to present the preview; and the full version of the premium content replaces the preview or reduced version of the premium content.

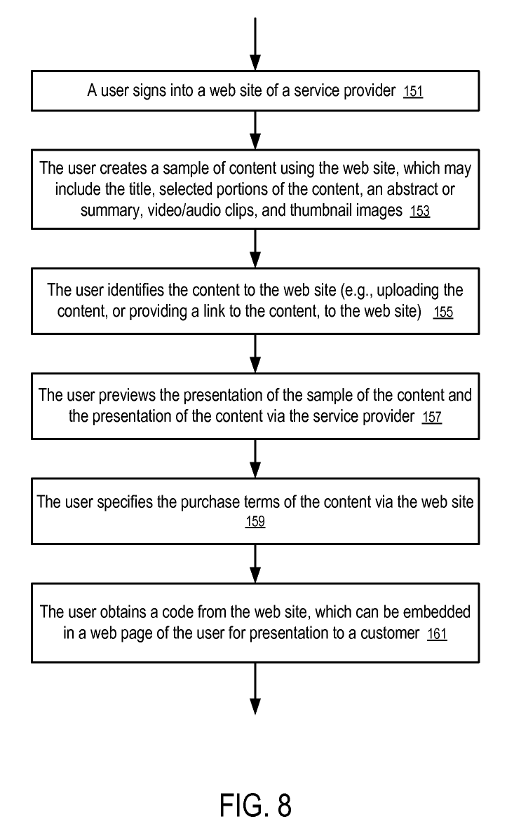

FIG. 8 shows a method to create an embeddable presentation of premium content according to one embodiment. In FIG. 8, a user signs (151) into a web site of a service provider of a web-based system. For example, after the user log in to wrap the content and create a premium content link, a landing page is presented with information customized according to preferences stored in the account of the user. However, the user does not have to log in to start the process. For example, the user may create the premium content link and then associate the premium content link with an account of the user to receive revenue generated from premium content.

In one embodiment, after the listing is previewed and the terms are set, it is determined whether the owner has logged in. If not, the owner may create an account with the web-based system and sign in. After verifying that the owner is logged in, a code for the premium content link is provided to the content owner.

In FIG. 8, the user creates (153) a sample of the content using the web site. The sample may include the title, selected portions of the content, an abstract or summary, video/audio clips, and/or thumbnail images. The sample can be used to create a reduced version of the premium content to provide a preview to a potential customer.

The user identifies (155) the content to the web site. For example, the user may upload the content to the server of the service provider, or provide to the web site of the service provider a link to the content. The user can optionally preview (157) the presentation of the sample of the content and the presentation of the content via the service provider. The user specifies (159) the purchase terms of the content via the web site, such as price, coupon, currency, distribution rules, whether the user allows others (e.g., affiliates) to sell the content on behalf of the user, the percentage or amount the user offers to affiliates for selling the content on behalf of the user, time to live of a purchase, etc. The user obtains (161) a code from the web site, which can be embedded in a web page of the user for presentation to a customer. The code represents the premium content link. The user can copy and paste the code into a web page to embed the premium content link in the web page.

In some embodiments, the content owner can also create a subscription package and allows customer having a valid subscription to access a set of premium contents. In some embodiments, the content owner can also request the web-based system to time the customer accessing the content. The customer may be charged based on the time (e.g., for watching a video clip or an audio clip).

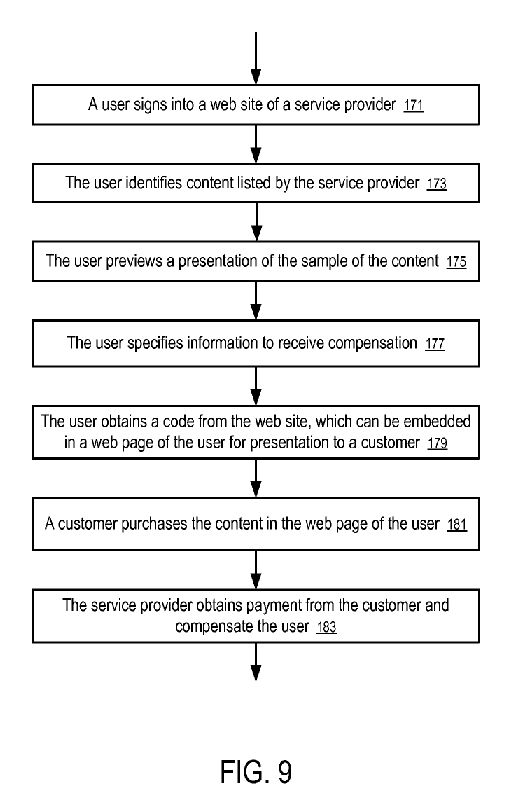

FIG. 9 shows a method to distribute contents according to one embodiment. In FIG. 9, a user signs (171) into a web site of a service provider. The user identifies (173) content listed by the service provider. For example, the user may search the database of the service providers for contents the user is interested in re-distributing. The user previews (175) a presentation of the sample of the content. The user specifies (177) information to receive compensation.

In some embodiment, a user does not have to sign into the web site to start the process. If the user already signed in the web site of the service provider, the user can simply confirm the previously recorded information to receive compensation. If the user has not signed in, the user is prompted to identify the account information prior to receiving the code that represents the premium content link. Alternatively, the user may create the premium content link and subsequently associate the premium content link with his/her account to receive affiliate revenue.

The user obtains (179) a code from the web site, which can be embedded in a web page of the user for presentation to a customer. If a customer purchases (181) the content in the web page of the user, the service provider obtains (183) payment from the customer and compensate the user.

In one embodiment, the user can identify premium content for distribution by selecting a link presented in a preview section embedded in web pages of others (e.g., a web page of the content owner or a web page of another affiliate), such as link (129) illustrated in FIG. 2. Alternatively, after the affiliate logs in with the web-based system, the affiliate is presented with a set of listings via a listing board or condensed listing page of pay to view items.

In one embodiment, after an affiliate signs into the web site of the service provider, the web site provides the affiliate with an interface to view a collection of pay to view listings the affiliate has signed up for as an affiliate for content re-distribution.

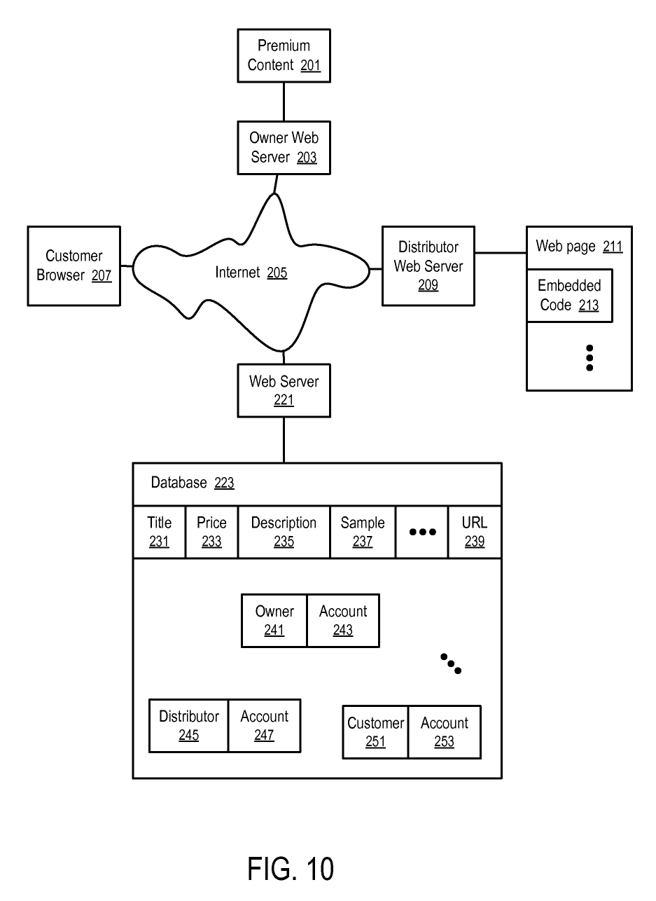

FIG. 10 shows a system to provide premium contents according to one embodiment. In FIG. 10, the content owner may host the premium content (201) at the owner web server (203). Since the content owner has control over the premium content (201) hosted on the web server (203), the content owner may optionally use various known technologies to protect the premium content (201) from unauthorized access and/or replication.

In FIG. 10, the web server (221) provides a web based service to allow the “in place” preview, purchase and viewing of the premium content (201) via premium content links. The web server (221) includes a database (223) storing information such as title (231), price (233), description (235), sample (237), . . . , and the URL (239) of the premium content (201).

In one embodiment, the database (223) is a centralized database. Alternatively, the information can be stored on a peer to peer network.

In one embodiment, a premium content link is provided as an embeddable code, such as code (213) embedded in the web page (211) hosted on the distributor web server (209). The distributor (209) and/or the web page (211) may be owned by an affiliate, or the content owner. In some embodiments, a same web server is used as both the owner web server (203) and the distributor web server (209).

When the customer browser (207) accesses the web page (211) over the Internet (205), the embedded code (213) causes the customer browser (207) to access the web server for a “in place” preview of the premium content. The web server (221) of the web-based service provider can generate a preview of the premium content based on the information such as title (231), price (233), description (235), sample (237), etc. The web server (221) also provides user interface elements (e.g., links or icon buttons) to request access to the premium content (201).

Once the customer uses the browser (207) to request access to the premium content (201), the web server (221) presents “in place” user interface for payment processing and order confirmation. Upon the completion of the order process, the web server (221) provides the URL (239) to the browser (207) to allow the browser to access the owner web server (203) for the premium content (201).

In FIG. 8, the embedded code (213) includes identifiers of the owner (241) and the distributor (245) in the database (223). After the customer (251) is identified in the database (223), the web server charges/debits the account (253) of the customer and credits the account (243) of the owner (241) and the account (247) of the distributor (245) to complete the payment processing.

In FIG. 8, the premium content (201) is not hosted in the web server (221) of the service provider. Alternatively, the premium content may also be hosted on the web server of the service provider.

In one embodiment, a representation of content is provided to a first user. The first user embeds the representation of the content into a web page. After the web page having the representation of the content is rendered in the browser, a web server receives a request from a browser made via the representation of the content. In response to the request, the web server presents a user interface to process a payment to access the content without the browser leaving the web page. The user interface may be provided in-line at the representation of the content in the web page or be provided in a pop-up window while the browser presents the web page. Upon completion of the payment, the web server causes the browser to present the content in the browser (e.g., in the web page).

In one embodiment, the representation of the content comprises a code, which is at least in part in a HyperText Markup Language (HTML) or a script executable in the browser.

In one embodiment, the web page is provided via an insecure connection with a first server; and the representation of the content embedded in the web page causes the browser to communicate with a second server over a secure connection to process the payment.

In one embodiment, the web server presents a reduced version of the content in the web page when the code contained in the web page is rendered in the web browser. The reduced version of the content may include a title, a description of the content, an abstract, a summary, a video clip, an audio clip, a thumbnail image, a price to access the content, and/or a selected portion of the content. In one embodiment, the reduced version of the content includes a user interface element selectable to initiate the request.

In one embodiment, to present the content in the browser the web server causes the browser to replace the reduced version of the content with a full version of the content in the web page.

In one embodiment, a user interface is presented to the first user to receive information about the content, which is stored in a centralized database and presented in the web page when the representation of the content contained in the web page is rendered in the web browser.

In one embodiment, the web server is further configured to receive a Uniform Resource Locator (URL) of the content from the first user, which is provided to the browser to cause the browser to present the content after the completion of the payment. In one embodiment, the centralized database is configured to store URL but not the content.

In one embodiment, the web server receives from the first user a price to access the content, where the payment is charged according to the price specified by the first user.

In one embodiment, a link is presented in the web page when the representation of the content is rendered in the web browser; and in response to a second user selecting the link in the web browser, the second user is identified and presented with a second representation of the content to the second user. The second user embeds the second representation of the content into a second web page. Information about the content is then presented when the second web page having the second representation of the content is rendered in a browser. The information about the content including a link to request access to the content. In response to a selection of the link to request access to the content by a third user, a user interface is presented to process a second payment from the third user. Upon completion of the payment, the content is presented to the third user; and the first and second users are compensated using portions of the second payment.

In one embodiment, a search interface is presented to a second user separate from the first user. In response to a search request from the search interface, a selectable search result is presented, which when selected causes the presentation of a second representation of the content. The second representation being associated with the second user and embeddable into a web page of the second user for a presentation of the content of the first user.

From this description, it will be appreciated that certain aspects are embodied in the user devices, certain aspects are embodied in the server systems, and certain aspects are embodied in a system as a whole. Embodiments disclosed can be implemented using hardware, programs of instruction, or combinations of hardware and programs of instructions.

In general, routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects disclosed may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the techniques. Thus, the techniques are neither limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
providing a representation of content to a first user, the representation of the content embeddable by the first user into a web page;
receiving a request from a browser after the web page having the representation of the content is rendered in the browser;
responsive to the request, presenting a user interface to process a payment to access the content without the browser leaving the web page; and
upon completion of the payment, presenting the content in the browser.

2. The method of claim 1, wherein the content is presented in the web page.

3. The method of claim 2, wherein the representation of the content comprises a code.

4. The method of claim 3, wherein the code is at least in part in a HyperText Markup Language (HTML) or a script executable in the browser.

5. The method of claim 3, wherein the web page is provided via an insecure connection with a first server; and the representation of the content embedded in the web page causes the browser to communicate with a second server over a secure connection to process the payment.

6. The method of claim 3, further comprising:
presenting a reduced version of the content in the web page when the code contained in the web page is rendered in the web browser.

7. The method of claim 6, wherein the reduced version of the content includes at least one of a title, a description of the content, an abstract, a summary, a video clip, an audio clip, a thumbnail image, a price to access the content, and a selected portion of the content.

8. The method of claim 6, wherein the presenting the content in the browser comprises replacing the reduced version of the content with a full version of the content in the web page.

9. The method of claim 6, wherein the reduced version of the content includes a user interface element selectable to initiate the request.

10. The method of claim 1, wherein the user interface is provided in-line at the representation of the content in the web page.

11. The method of claim 1, wherein the user interface is provided in a pop-up window while the browser presents the web page.

12. The method of claim 1, further comprising:
presenting a user interface to the first user to receive information about the content;
storing the received information in a centralized database; and
presenting the information in the web page when the representation of the content contained in the web page is rendered in the web browser.

13. The method of claim 12, further comprising:
receiving a Uniform Resource Locator (URL) of the content from the first user; and
providing the URL to the browser to cause the browser to present the content after the completion of the payment.

14. The method of claim 13, wherein the centralized database is configured to store URL but not the content.

15. The method of claim 12, further comprising:
receiving from the first user a price to access the content, wherein the payment is charged according to the price specified by the first user.

16. The method of claim 1, further comprising:
presenting a link in the web page when the representation of the content is rendered in the web browser; and
in response to a second user selecting the link in the web browser, identifying the second user and presenting a second representation of the content to the second user, the second representation of the content embeddable by the second user into a second web page.

17. The method of claim 16, further comprising:
presenting information about the content when the second web page having the second representation of the content is rendered in a browser, the information about the content including a link to request access to the content;
in response to a selection of the link to request access to the content by a third user, presenting a user interface to process a second payment from the third user to access the content;
upon completion of the payment, presenting the content to the third user and compensating the first and second users using portions of the second payment.

18. The method of claim 1, further comprising:
providing a search interface to a second user separate from the first user;
in response to a search request from the search interface, presenting a selectable search result; and
responsive to the second user selecting the search result, presenting a second representation of the content, the second representation being associated with the second user and embeddable into a web page of the second user for a presentation of the content of the first user.

19. A system, comprising:
means for providing a representation of content to a first user, the representation of the content embeddable by the first user into a web page;
means for receiving a request from a browser after the web page having the representation of the content is rendered in the browser;
means for presenting, responsive to the request, a user interface to process a payment to access the content without the browser leaving the web page; and
means for presenting the content in the browser upon completion of the payment.

20. A machine readable media storing instructions, the instruction causing a system to perform a method, the method comprising:
providing a representation of content to a first user, the representation of the content embeddable by the first user into a web page;
receiving a request from a browser after the web page having the representation of the content is rendered in the browser;
responsive to the request, presenting a user interface to process a payment to access the content without the browser leaving the web page; and
upon completion of the payment, presenting the content in the browser.
